(19) United States
(12) Patent Application Publication
(10) Pub. No.: US 2018/0370259 A1
(43) Pub. Date: Dec. 27, 2018

(54) MOVE BAIL ARMS

(71) Applicant: Hewlett-Packard Development Company, L.P., Houston, TX (US)

(72) Inventors: Hunter Dane Cantrell, Vancouver, WA (US); Daniel Fredrickson, Vancouver, WA (US); Kevin Lo, Vancouver, WA (US); Emma Kelp-Stebbins, Vancouver, WA (US)

(21) Appl. No.: 15/630,876

(22) Filed: Jun. 22, 2017

(51) Int. Cl. B41J 13/20; B41J 13/00

(52) U.S. Cl. CPC B41J 13/20; B65D 25/325; B41J 13/0018

(57) ABSTRACT

Examples disclosed herein relate to moving a bail arm. Examples include to determine a size of a medium to be ejected to an output tray; acquire a fill state of the output tray; and raise a bail arm to a first position above a receiving surface of the output tray when the size of the medium is larger than a size threshold and the fill state is lower than a stack height threshold.

### BACKGROUND

Sheet outputting devices—including printers, finisher, copiers, scanners, fax machines, multifunction printers, all-in-one devices, or other devices—process and output a medium such as plain paper, photo paper, transparencies, etc. In some examples, sheet outputting devices can output stacks of metals or polymeric media, such as Compact Discs, in addition to or instead of a broad and thin medium. Sheet outputting devices may output multiple sheets of a medium into an output tray.

### BRIEF DESCRIPTION OF THE DRAWINGS

The following detailed description references the drawings, wherein:

FIG. 1 is a block diagram of an example imaging device;

FIG. 2A is a block diagram of an example system to change a position of a bail arm of an imaging device;

FIG. 2B is an example of a partial representation of the imaging device of FIG. 2A; and

FIG. 3 is a flowchart of an example method for moving a bail arm of an imaging device.

### DETAILED DESCRIPTION

An “imaging device” may be any hardware device, such as a printer, multifunction printer (MFP); or any other device with functionalities to physically produce representation(s) (e.g., text, images, models, etc.) on a medium. In examples, a “medium” may include paper, photopolymers, thermopolymers, plastics, composite, metal, wood, or the like. In some examples, an MFP may be capable of performing a combination of multiple different functionalities such as, for example, printing, photocopying, scanning, faxing, etc. For example, the function within an imaging device may be to reboot the imaging device, troubleshoot the imaging device, upgrade firmware, retrieve consumable level information, clone features, adjust security settings, perform a test, retrieve a scan, execute a print request, clear an alert, etc.

A number of imaging devices output sheets of a medium into an output bin or output tray for retrieval. The size of output medium may vary. The speeds at which imaging devices process a medium has been increasing. For example, printing speeds and scanning speeds of imaging devices are increasing. As a result, media are being output to the output tray or output bin at increasing rates. Bail arms have been used to control media from ejecting off the output tray. In an example, a number of different print jobs or scan jobs with different sized media may be output by an imaging device to an output tray within a short period of time. However, a user may not retrieve the output media immediately. As a result, bail arms may be used to control large volumes of different sized media on an output tray. The dimensions of a bail arm may be chosen to control the smallest sized media to be outputted by an imaging device. However, such bail arms may not allow larger sized media to slide underneath the bail arm smoothly. In other examples, such bail arms may interfere with larger sized media such that they may not come to rest on top of a media stack on the output tray.

To address these issues, in the examples described herein, a device is described which includes a bail arm to control output media. The device includes a driving mechanism to move or lift the bail arm to allow media of different sizes to be ejected onto the output tray. In some examples, the bail arm may be moved according to various parameters of the imaging device and a print job being processed. In examples, the bail arm may be moved to a position outside an ejection path of a medium being ejected onto the output try under some conditions. In some examples, a counterweight may be applied to the bail arm to reduce the effective weight of the bail arm on a medium being ejected onto the output tray. In such examples, when and where to move a bail arm and when to apply a counterweight to the bail arm may be determined according to various parameters to reduce interference to the ejection of a different sized media.

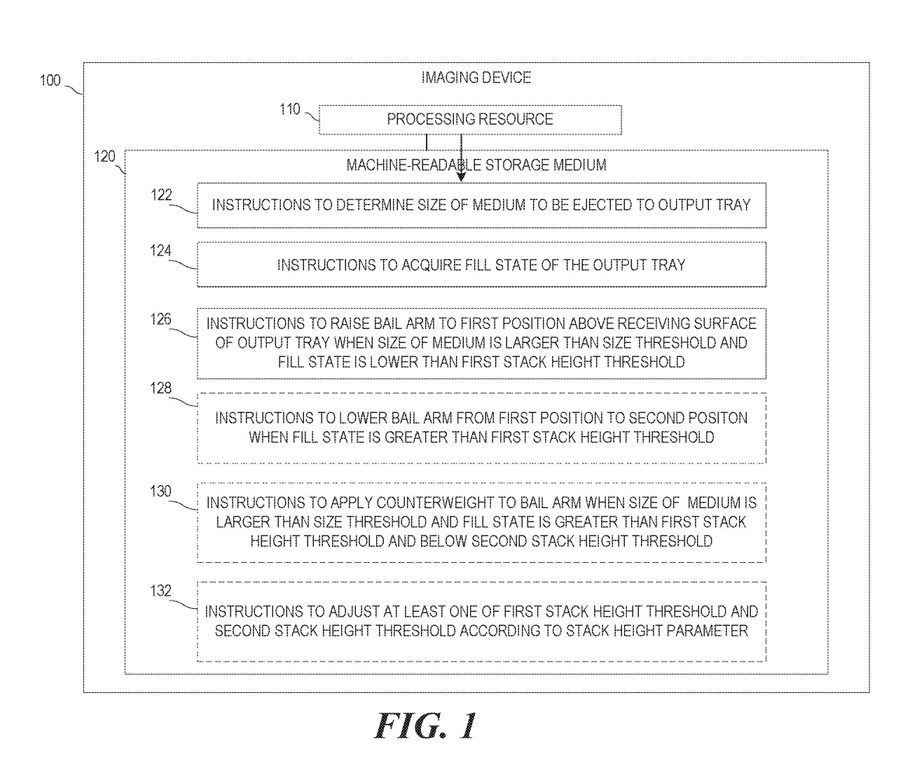

Referring now to the drawings, FIG. 1 is a block diagram of an example imaging device 100 to move a bail arm of an imaging device. In the example of FIG. 1, imaging device 100 includes a processing resource 110 and a machine-readable storage medium 120 comprising (e.g., encoded with) instructions 122, 124, 126, 128, 130, and 132 executable by processing resource 110. In some examples, storage medium 120 may include additional instructions. In some examples, instructions 122, 124, 126, 128, 130, 132, and any other instructions described herein in relation to storage medium 120, may be stored on a machine-readable storage medium remote from but accessible to imaging device 100 and processing resource 110 (e.g., via a computer network). In some examples, instructions 122, 124, 126, 128, 130, and 132 may be instructions of a computer program, computer application (“app”), agent, or the like, of imaging device 100. In other examples, the functionalities described herein in relation to instructions 122, 124, 126, 128, 130, and 132 may be implemented as engines comprising any combination of hardware and programming to implement the functionalities of the engines, as described below.

In examples described herein, a processing resource may include, for example, one processor or multiple processors included in a single imaging device (as shown in FIG. 1) or distributed across multiple imaging devices. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof. Processing resource 110 may fetch, decode, and execute instructions stored on storage medium 120 to perform the functionalities described below. In other examples, the functionalities of any of the instructions of storage medium 120 may be implemented in the form of electronic circuitry, in the form of executable instructions encoded on a machine-readable storage medium, or a combination thereof.

As used herein, “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In the example of FIG. 1, instruction 122 may determine a size of a medium to be ejected to an output tray or output bin of an imaging device 100. In examples, the medium may be any type of medium that imaging device 200 may process. As used herein a “size” of a medium refers to dimensions of a medium in at least two-dimensions (i.e., in a plane). In some examples, the dimensions of a medium in two-dimensions may refer to the size of at least two sides of the medium. In some examples, the sides may include sides of varying sizes, such as, a length of the medium or a width of the medium.

In examples, the size of a medium may be determined via a sensor. In such examples, a media size sensor of imaging device 100 may determine the size of at least one side of a medium to be ejected into an output bin or output tray. For example, the media size sensor may determine a length of a medium. In other examples, the media size sensor may determine a width of a medium. In examples, the medium size sensor may be any type of sensor to detect a size of a medium, such as, an optical sensor, a temperature sensor, a power sensor, etc. In some examples, an optical sensor may be disposed in imaging device 100 to determine the size of a side of a medium traveling therethrough. For example, an optical sensor may be disposed along a media path through imaging device 100 to detect when a medium has traveled past the sensor. In such examples, based on the duration of time the optical sensor detects a presence of the medium, imaging device 100 may determine a size of the medium along, for example, the media path. In some examples, the media size sensor may determine the size of a side of the medium along an ejection path of imaging device 100. In examples, the side of the medium along the ejection path may be either a length or a width of the medium. As used herein, the term “ejection path” refers to a path made by or followed by a medium as it enters an output tray of imaging device 100 and comes to rest on the output tray. In examples, a number of parameters of imaging device 100 may influence the ejection path, including, for example, dimensions of the output tray, a media stack height in the output tray, etc. In examples, the ejection path may curve as the medium curves and/or buckles while entering the output tray of imaging device 100. A medium may curve or buckle due to the stiffness of the medium. In examples, a number of factors may influence the stiffness of an ejected medium. In examples, the stiffness of a medium may be related to various parameters of an imaging device (e.g., a humidity level, a temperature level, etc.) and/or the medium (e.g., a length of the medium, a paper type, a dot density of a print job on the medium, dual-side indicator, etc.).

In examples, a media size sensor may be disposed in any location in an imaging device. For example, the media size sensor may be disposed in an input tray of the imaging device. In other examples, the media size sensor may be disposed in the output tray of imaging device 100. In some examples, the media size sensor may be integrated with another component of the imaging device. For example, the media size sensor may be integrated into a controller of a print engine of imaging device 100. In such an example, the controller may determine the size of the medium according to various other parameters of the imaging device 100, such as a temperature of a print engine, a power usage, etc. In other examples, the size of a medium may be determined from a job acquired by imaging device 100. As used herein, a “job” or “print job” refers to a set of instructions to produce a physical object on a medium based on electronic data, such as a printed document, a printed photograph, etc.

In instructions 124, a fill state of the output tray of imaging device 100 may be acquired. As used herein, a “fill state” of an output tray refers to an indicator of how much of an output tray contains or retains output media. In example, a fill state may indicate whether a medium is present in an output tray. In other examples, a fill state may indicate an approximate height of any media stack in the output tray. In examples, the fill state may be passively acquired (i.e., received) or actively acquired (i.e., retrieved) from a sensor.

In examples, the fill state of the output tray may be acquired from a stack height sensor to detect the presence of a medium and/or stack height of a media stack in the output tray of imaging device 100. In examples, as used herein, a “stack height” or “media stack height” refers to a height of a stack of media on a receiving surface of an output tray of imaging device 100. In examples, the stack height may be measured along a normal extending from the receiving surface of the output tray. In examples, a stack height sensor may determine the weight of a stack of media on an output tray to determine a fill state. In another example, the stack height sensor may be an optical sensor to determine a stack height by measuring a time of reflection along an optical path extending into the output tray. In such an example, as the media stack increases, the time for reflection along the optical path of the stack height sensor may decrease in proportion to the stack height. In other examples, the sensor may include an encoder coupled to the bail arm to determine a height of the media stack according to the location of the bail arm in the output tray or rotation of the bail arm around a central axis.

In other examples, the fill state may be acquired by processing resource 100 according to various parameters of a media ejected on the output tray, such as a page count, a paper type, a paper weight, etc. For example, determining a count of media ejected to the output tray within a duration of time may be used to determine a stack height. In examples, the fill state may be acquired from a combination of the stack height sensor and processing resource 100. In such an example, an ejected medium may not come to rest on a media stack fast enough for the stack height sensor to provide an accurate measure of the fill state. In such examples, processing resource 100 may determine the stack height based on data from the stack height sensor and, for example, a page count of ejected media.

In instructions 126, imaging device 100 may raise a bail arm to a first position when the size of the medium is larger than a size threshold and the fill state is lower than a stack height threshold. In examples, the first position may be a position above a receiving surface of the output bin or output tray of imaging device 100. In such an example, the first position may be a position in which the bail arm is located outside the ejection path of the medium. In examples, as used herein, a “size threshold” refers to a threshold of a size of the medium to be ejected to the output tray or output bin of imaging device 100. As used herein, a “stack height threshold” refers to a threshold of a height of a stack of media disposed on the receiving surface of the output tray or output bin of imaging device 100.

In examples, the size threshold may be determined according to various parameters of imaging device 100 and/or the medium to be ejected to the output tray or output bin of imaging device 100. For example, the size threshold may be related to a dimension of a bail arm of imaging device 100. In such an example, the size threshold may be related to a length of the bail arm along the ejection path of the medium. In an example, a medium with a length greater than a length of the bail arm along the ejection path may be determined to be above the size threshold. In other examples, a medium with a length along an ejection path greater than a length of a bail arm along the ejection path may not be determined to be above the size threshold. In examples, the size threshold may be related to a fill state of the output tray of imaging device 100. In such an example, the size threshold may vary according to the presence of an output medium or height of a media stack in the output tray of imaging device 100. In an example, if a media stack of a certain height is detected in the output tray, the size threshold of a medium to raise the bail arm may change. In yet another examples, a humidity level of a printing environment may be related to the size threshold. In such an example, a humidity sensor may provide a humidity level to imaging device 100. In an example, in a higher humidity environment, the medium may absorb ambient moisture and become more flexible and less stiff and thereby apply less force to move a bail arm out of an ejection path of the medium.

In examples, the size threshold may be determined according to characteristics of the medium to be ejected onto the output tray of imaging device 100. In such an example, a weight of a medium to be ejected onto the output tray of imaging device 100 may be related to the size threshold. In another examples, a stiffness of a medium to be ejected onto the output tray of imaging device 100 may be related to the size threshold. In other examples, a paper type, such as, construction paper, card stock, envelop, etc., may be related to the size threshold. In yet another example, a dot density of a print job may be related to the size threshold. In examples, the “dot density may refer to the density of ink or toner dots at random locations on the medium. In other examples, the dot density may refer to the density ink or toner dots at specific locations on the medium. In an example, a higher dot density of a print job may indicate the output medium may be more flexible, for example, from absorbing the moisture associated with an ink, a toner, or other fluid deposited on the medium. In an example, a dual-side indicator of an ejected medium may be related to the size threshold. In such an example, when a dual-side indicator indicates the ejected medium was printed on two sides, the ejected medium may meet the size threshold to raise or move the bail arm. In examples, a medium with a dual-side print job may not be stiff enough to move a bail arm out of an ejection path of the medium, for example, due to the absorption of an ink, a toner, or other fluid deposited on the medium.

In examples, the stack height threshold may be determined according to a stack height parameter of imaging device 100 and/or the medium to be ejected to the output tray of imaging device 100. In examples, a stack height parameter may be at least one of a height of a media stack on a receiving surface of the output tray, a dot density of a print job on the ejected medium, a paper type, a dual-side indicator, a humidity level, a temperature level, a length or size of the medium being ejected. In an example, as a height of a media stack in an output bin increases, the bail arm resting on the media stack changes a rotational angle around a central axis of the bail arm. As the angle of rotation of the bail arm changes, the effective weight of the bail arm on the media stack may vary. For example, at rest on an empty output bin, the effective weight of the bail arm on the receiving surface of the output try may be the highest. In such an example, a medium ejected onto the output tray may need to apply the highest force to move the bail arm out of an ejection path when the bail arm is at rest on the output tray. In examples, as the stack height increases, the bail arm may rotate upward and may apply less force along the direction of the force of gravity to the media stack. In examples, the stack height threshold may be set to a level below which the effective weight of the bail arm on the output tray may interfere with ejection of a medium. In examples, the bail arm may be moved to the first position when the fill state is lower that the stack height threshold to allow a medium to be ejected onto the output tray without interference.

In some examples, the bail arm may be lowered from the first position to a second position when the fill state of the output tray is greater than the stack height threshold. In such an example, the second position may be a position in which the bail arm is located in the ejection path of the medium. For example, at least a portion of the bail arm may be at rest on the output tray or a media stack disposed thereon in the second position. In other examples, the second position may be a position in which the bail arm is not resting on another object, in other words, the second position may be a position in which the bail arm hovers over the receiving surface of the output bin or output tray. In some examples, a counterweight may be applied to the bail arm in the second position to reduce its effective weight on a medium to be ejected onto the output tray of imaging device 100. In such examples, the counterweight may be applied by a force providing member. In examples, the force providing member may provide a counter force to the force of gravity on the bail arm such that a force applied by the bail arm on the output tray is less than the force of gravity on the bail arm. In examples, the force providing member may be any type of member to apply a force. For example, the force providing member may be a spring, such as a coiled torsion spring.

In some examples, imaging device 100 may apply a counterweight or counterforce to the bail arm while the height of the media stack is within a range. In such examples, the lower end of the range of the stack height threshold may be a level below which the effective weight of the bail arm on the output tray may interfere with ejection of a medium. In such examples, the higher end of the range of the stack height threshold may be a second stack height threshold above which the effective weight of the bail arm may not interfere with ejection of a medium. In such examples, when a media stack reaches the second stack height threshold the bail arm's effective weight may be sufficient to allow ejection of a medium onto the media stack. In examples, the range of the stack height threshold may be between 0 mm and 25 mm. In other examples, the range of the height of the media stack may be between 0 mm and 200 mm.

In examples, the range of the stack height threshold through which a counterweight is applied to the bail arm may vary according to various parameters. In such examples, the of the stack height threshold may vary according to any parameter which may affect the force that an ejected medium may apply to move the bail arm out of the ejection path of the medium. For example, any of the stack height parameters may affect the stiffness of a medium being ejected onto the output tray. For example, the dot density of a job printed on the ejected medium may be correlated with how much moisture the medium has absorbed which in turn may affect how stiff the media is and how much force it may apply to the bail arm. In some examples, the applied counterweight may vary according to stack height parameters. In other examples, the applied counterweight may be constant regardless of the stack height parameters. In examples, the counterweight may be applied to the bail arm when the stack height is within the range of the stack height threshold. In other examples, the counterweight may be applied to the bail arm when the stack height is within the range of the stack height threshold and the size or length of the medium to be ejected is greater than the size threshold. In some such examples, the range of the stack height threshold may be between 0 mm and 200 mm. In other such examples, the range of the stack height threshold may be between 0 mm and 25 mm.

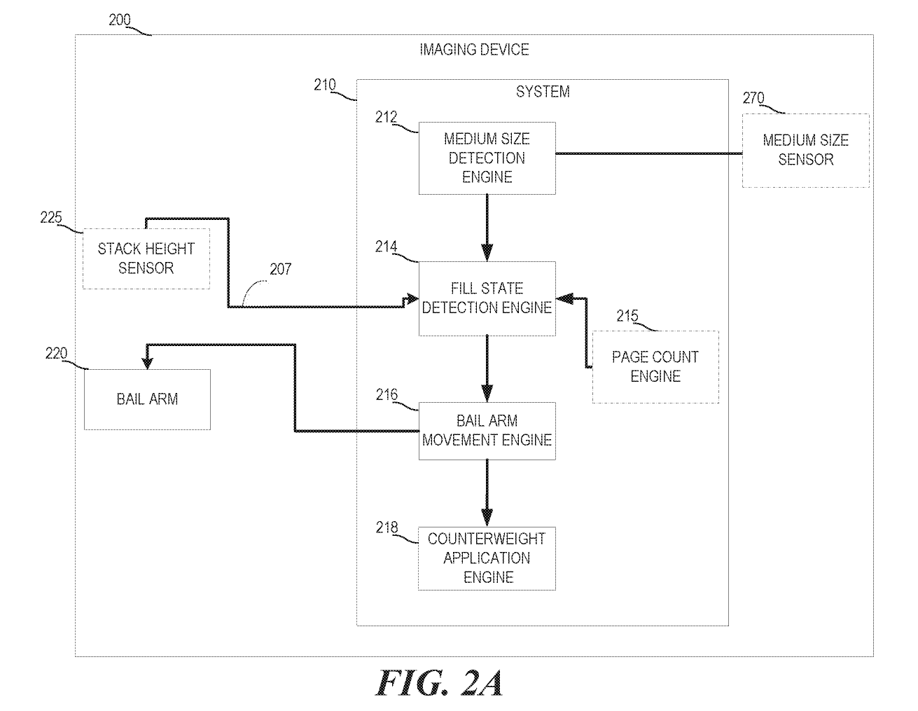

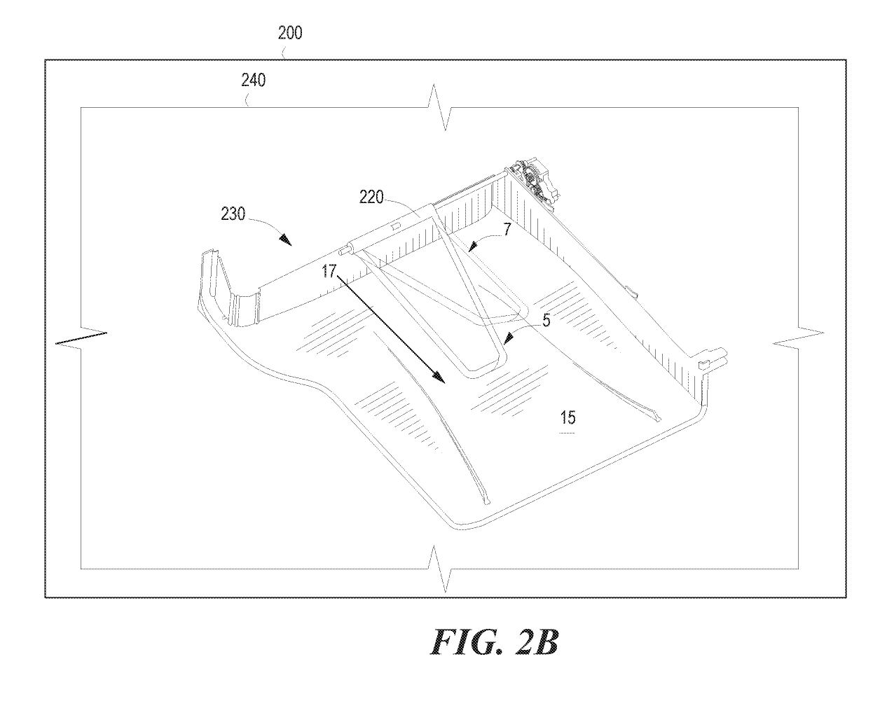

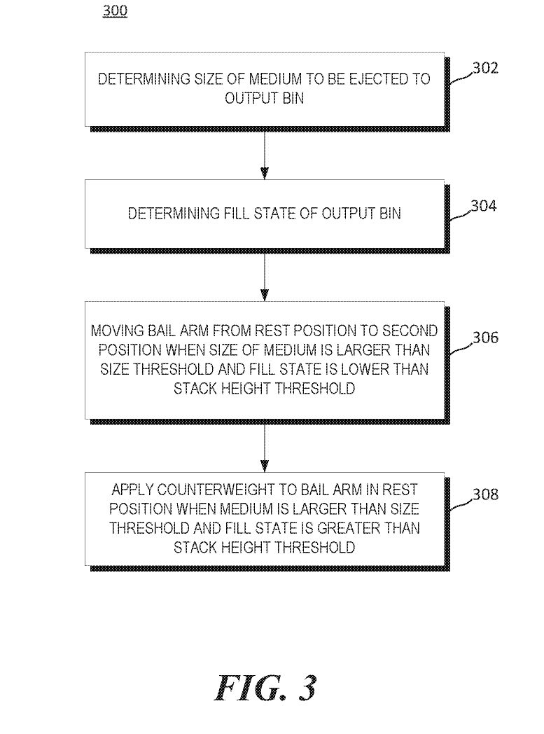

In some examples, instructions 122, 124, 126, 128, 130, and 132 may be part of an installation package that, when installed, may be executed by processing resource 110 to implement the functionalities described herein in relation to instructions 122, 124, 126, 128, 130 and, 132. In such examples, storage medium 120 may be a portable medium, such as a CD, DVD, flash drive, or a memory maintained by an imaging device from which the installation package can be downloaded and installed. In other examples, instructions 122, 124, 126, 128, 130, and 132 may be part of an application, applications, or component already installed on imaging device 100 including processing resource 110. In such examples, the storage medium 120 may include memory such as a hard drive, solid state drive, or the like. In some examples, functionalities described herein in relation to FIG. 1 may be provided in combination with functionalities described herein in relation to any of FIGS. 2A-3.

FIG. 2A is a block diagram of an example system 210 to change a position of a bail arm of an imaging device 200. In some examples, system 210 may be disposed in an imaging device 200. In the example of FIG. 2A, system 210 includes at least some of engines 212, 214, 215, 216, and 218 which may be any combination of hardware and programming to implement the functionalities of the engines. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 212, 214, 215, 216, and 218. In such examples, system 210 may include the machine-readable storage medium storing the instructions and the processing resource to execute the instructions, or the machine-readable storage medium may be separate but accessible to system 210 and the processing resource.

In some examples, the instructions can be part of an installation package that, when installed, can be executed by the processing resource to implement at least engines 212, 214, 215, 216, and 218. In such examples, the machine-readable storage medium may be a portable medium, such as a CD, DVD, or flash drive, or a memory maintained by an imaging device from which the installation package can be downloaded and installed. In other examples, the instructions may be part of an application, applications, or component already installed on system 210 including the processing resource. In such examples, the machine-readable storage medium may include memory such as a hard drive, solid state drive, or the like. In other examples, the functionalities of any engines of system 210 may be implemented in the form of electronic circuitry.

In the example of FIG. 2A, a medium size engine 212 may determine a length of a medium to be ejected into or onto an output bin or output tray imaging device 200 along an ejection path of the medium. In examples, the medium may be any type of medium that imaging device 200 may process. In examples, the length of the medium may be detected by a medium size sensor 270. Medium size sensor 270 may be any type of sensor to detect a size of a medium as described above with respect to FIG. 1. In examples, medium size sensor 270 may be an optical sensor to determine the length of the medium. In examples, medium size sensor 270 may be disposed in any location in imaging device 200. For example, medium size sensor 270 may be disposed in an input tray of the imaging device. In other examples, medium size sensor 270 may be disposed in the output tray of imaging device 200. In some examples, medium size sensor 270 may be integrated with another component of imaging device 200. For example, medium size sensor 270 may be integrated into a controller of a print engine of imaging device 200. In such an example, the controller may determine the length of the medium along the ejection path according to various other parameters of the imaging device 200, such as a temperature of the print engine, a power usage, etc. In other examples, the length of the medium along the ejection path may be determined from a job acquired by imaging device 200.

In examples, fill state detection engine 214 may determine a media stack height on the output bin. In examples, the media stack height may be acquired from a stack height sensor 225. Stack height sensor 225 may be any type of sensor to detect the presence of a medium and/or stack height of a media stack in the output bin as described above with respect to FIG. 1. For example, stack height sensor 225 may be an optical sensor to measure the time of reflection along an optical path extending into the output bin. In such an example, as the media stack increases, the time for reflection along the optical path of stack height sensor 225 may decrease in proportion to the media stack height. In other examples, fill state detection engine 214 may determine the media stack height according to various parameters of ejected media, such as, a page count, a paper type, a paper weight, etc. In one such example, a page count engine 215 may count the number of sheets of medium ejected onto the output tray and fill state detection engine 214 may determine the media stack height accordingly. In other examples, fill state detection engine 214 may determine the media stack height from a combination of data from stack height sensor 225 and parameter(s) of ejected media, such as a page count, a paper type, a paper weight, etc.

In examples, bail arm movement engine 216 may move a bail arm 220 from a first position to a second position if the length of the medium is greater than a length threshold and the media stack height is within a range. Referring now to FIG. 2B, FIG. 2B is an example of a partial representation of imaging device 200 of FIG. 2A. In the example of FIG. 2B, an output bin assembly 240 is depicted with bail arm 220 extending over output bin 230. In examples, output bin 230 includes receiving surface 15 to receive a medium following an ejection path 17. In the example of FIGS. 2A-2B, first position 5 may be a position in which at least a portion of bail arm 220 is in contact with an output bin 230 of imaging device 200 (e.g., at rest on receiving surface 15). In other examples, first position 5 may be a position in which at least a portion of bail arm 220 is in contact with a media stack disposed on output bin 230 (not shown). In examples, second position 7 may be outside of ejection path 17 of the medium to be ejected onto or into output bin 230.

In examples, the length threshold may be determined according to various parameters of imaging device 200 and/or a medium to be ejected to output bin 230. In examples, the length threshold may be determined according to any of the parameters described above with reference to the size threshold of FIG. 1.

In examples, the range of the media stack height may be determined according to a stack height parameter. In examples, the lower end of the range of the media stack height may refer to a range of a stack height threshold. In such an example, the lower end of the range of the media stack height may be a level below which the effective weight of bail arm 220 on output bin 230 may interfere with ejection of a medium along ejection path 17. In such examples, the higher end of the range of the media stack height may be a stack height above which the effective weight of bail arm 220 may not interfere with ejection of a medium along ejection path 17.

In examples, counterweight application engine 218 may apply a counterweight to bail arm 220 when the media stack height is within the range. In examples, the counterweight may be applied by a force providing member. The force providing member may be any type of member to apply a force described above with respect to FIG. 1. In examples, the counterweight may be applied to bail arm 220 according to various parameters of imaging device 200 and/or a medium to be ejected to output bin 230. In examples, a counterweight may be applied to reduce the effective weight of bail arm 220 to allow an ejected medium to move bail arm 220 out of ejection path 17. In some examples, the applied counterweight may vary according to stack height parameters. In other examples, the applied counterweight may be constant regardless of stack height parameters. In examples, the counterweight may be applied to bail arm 220 when the stack height is within the range of the media stack height. In other examples, the counterweight may be applied to bail arm 220 when the stack height is within the range of the media stack height and the length of the medium along ejection path 17 is greater than a length threshold. In such examples, the range of the stack height may be between 0 mm and 200 mm. In examples, the length threshold may be similar to the size threshold described above with reference to FIG. 1

FIG. 3 is a flowchart of an example method 300 for moving a bail arm of an imaging device. Although execution of method 300 is described below with reference to system 210 of FIGS. 2A-2B described above, other suitable systems for the execution of method 300 can be utilized (e.g., imaging device 100). Additionally, implementation of method 300 is not limited to such examples.

At 302 of method 300, medium size detection engine 212 may determine a size of a medium to be ejected to output bin 230 of imaging device 200.

At 304, fill state detection engine 214 may determine a fill state of output bin 230 of imaging device 200. In examples, fill state detection engine 214 may determine a fill state of output bin 230 by counting a number of sheets of medium ejected to output bin 230. In examples, fill state detection engine 214 may determine a fill state of output bin 230 by acquiring a stack height from a stack height sensor 225.

At 306, bail arm movement engine 216 may move bail arm 220 from a rest position to a second position when the size of the medium is larger than a size threshold and the fill state is lower than a stack height threshold. In the example of FIG. 3, the second position may be outside ejection path 217 of the medium. In examples, ejection path 17 of the medium may be determined according to at least one of the length of the medium, a height of a media stack on receiving surface 15 of the output bin 230, a dot density of a print job on the ejected medium, a paper type, a dual-side indicator, a humidity level, a temperature level.

At 308, counterweight application engine 218 may apply a counterweight to bail arm 220 in the rest position when the medium is larger than the size threshold and the fill state is greater than the stack height threshold.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to AG. 3 may be provided in combination with functionalities described herein in relation to any of FIGS. 1-2B. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. A non-transitory machine-readable storage medium comprising instructions executable by a processing resource to:
determine a size of a medium to be ejected to an output tray;
acquire a fill state of the output tray; and
raise a bail arm to a first position above a receiving surface of the output tray when the size of the medium is larger than a size threshold and the fill state is lower than a first stack height threshold.

2. The storage medium of claim 1, further comprising:
lower the bail arm from the first position to a second position when the fill state is greater than the first stack height threshold.

3. The storage medium of claim 2, wherein at the second position at least a portion of the bail arm is in contact with a media stack.

4. The storage medium of claim 1, further comprising:
apply a counterweight to the bail arm when the size of the medium is larger than the size threshold and the fill state is greater than the first stack height threshold and below a second stack height threshold.

5. The storage medium of claim 4, further comprising:
adjust at least one of the first stack height threshold and the second stack height threshold according to a stack height parameter.

6. The storage medium of claim 5, wherein the stack height parameter is at least one of a height of a media stack on a receiving surface of the output tray, a dot density of a print job on the medium, a paper type, a dual-side indicator, a humidity level, a temperature level, a length of the medium.

7. A system to change a position of a bail arm, comprising:
a medium size detection engine to determine a length of a medium to be ejected onto an output bin along an ejection path of the medium;
a fill state detection engine to determine a media stack height on the output bin;
a bail arm movement engine to move a bail arm from a first position to a second position if the length of the medium is greater than a length threshold and the media stack height is within a range, the second position being outside of the ejection path; and
a counterweight application engine to apply a counterweight to the bail arm when the media stack height is within the range.

8. The system of claim 7, further comprising:
a stack height sensor to detect the presence of a second medium in the output bin and detect the media stack height in the output bin.

9. The system of claim 7, further comprising:
a page count engine to count the number of media ejected to the bin to determine the media stack height.

10. The system of claim 7, wherein the ejection path of the medium is determined by the medium size detection engine according to at least one of the length of the medium, the media stack height, a dot density of a print job on the medium, a paper type, a dual-side indicator, a humidity level, a temperature level.

11. The system of claim 7, wherein the medium size detection unit acquires the length of the medium from a print job.

12. A method for moving a bail arm of an imaging device, comprising:
determining a size of a medium to be ejected to an output bin;
determining a fill state of the output bin;
moving the bail arm from a rest position to a second position when the size of the medium is larger than a size threshold and the fill state is lower than a stack height threshold, the second position being outside an ejection path of the medium; and
apply a counterweight to the bail arm in the rest position when the medium is larger than the size threshold and the fill state is greater than the stack height threshold.

13. The method of claim 12, wherein the ejection path of the medium is determined according to at least one of the length of the medium, a height of a media stack on a receiving surface of the output bin, a dot density of a print job on the ejected medium, a paper type, a dual-side indicator, a humidity level, a temperature level.

14. The method of claim 12, wherein determining a fill state of the output bin includes counting a number of sheets of a second medium ejected to the output bin.

15. The method of claim 12, wherein determining a fill state of the output bin includes acquiring a stack height from a sensor.
